(19) United States
(12) Patent Application Publication
(10) Pub. No.: US 2026/0298176 A1
(43) Pub. Date: Oct. 1, 2026

(54) THRUST AUGMENTATION VIA PARTIAL CORE EXHAUST REHEAT

(71) Applicant: General Electric Company, Evendale, OH (US)

(72) Inventors: Brandon W. Miller, Evendale, OH (US); Jeffrey D. Rambo, Evendale, OH (US); Arthur W. Sibbach, Boxford, MA (US)

(21) Appl. No.: 19/095,274

(22) Filed: Mar. 31, 2025

(51) Int. Cl. F02K 1/15; F23R 3/28

(52) U.S. Cl. CPC F02K 1/15; F23R 3/28

(57) ABSTRACT

An aircraft engine includes a fan, an engine core downstream of the fan, a bypass airflow duct downstream of the fan, a core airflow duct extending through the engine core and including a core combustion chamber, and an augmented thrust airflow duct in communication with the core airflow duct and including an augmenter combustion chamber. The fan accelerates airflow through the bypass airflow duct to produce a first thrust, airflow through the core airflow duct is combusted within the core combustion chamber to produce a second thrust, and airflow diverted from the core airflow duct through the augmented thrust airflow duct is combusted within the augmenter combustion chamber to produce an augmented thrust.

### FIELD

This disclosure relates to engines for aircraft and, more particularly, to turbofan thrust augmentation via partial core exhaust reheat.

### BACKGROUND

In a turbofan engine, for example, air enters the intake and is accelerated by a fan to provide two different airflows: a core airflow and a bypass airflow. With respect to the bypass airflow, the acceleration of air through the fan and along the bypass airflow to the exhaust produces thrust.

The core airflow passes through one or more compressors, a combustion section (wherein the airflow is mixed with fuel and ignited for combustion), and one or more turbines. The combustion heats and expands the core airflow such that the core airflow is accelerated as it flows to the exhaust, thereby providing additional thrust.

### BRIEF DESCRIPTION OF THE DRAWINGS

Features of this disclosure will become more apparent in view of the following detailed description when taken in conjunction with the accompanying drawings, wherein:

FIG. 1 is a cross-sectional view of a portion of a turbofan engine in accordance with this disclosure.

FIG. 2 is an enlarged view of the area of detail designated as “2” in FIG. 1.

FIG. 3 is an enlarged, cross-sectional view a portion of another turbofan engine in accordance with this disclosure with a thrust augmenter disposed in a first configuration.

FIG. 4 is an enlarged, cross-sectional view of the portion of the turbofan engine of FIG. 3, with the thrust augmenter disposed in a second configuration.

FIG. 5 is a cross-sectional view illustrating a door configured for use with the thrust augmenter of the turbofan engine of FIG. 1.

FIG. 6 is a cross-sectional view illustrating another door configured for use with the thrust augmenter of the turbofan engine of FIG. 1.

### DETAILED DESCRIPTION

Approximating language, as used herein, is applied to modify any quantitative representation that could permissibly vary without resulting in a change in the basic function to which it is related. Accordingly, a value modified by a term or terms, such as “about,” “approximately,” “generally,” and “substantially” is not to be limited to the precise value specified. In at least some instances, the approximating language may correspond to the precision of an instrument for measuring the value, or the precision of the methods or the machines for constructing the components and/or the systems or manufacturing the components and/or the systems. For example, the approximating language may refer to being within a one, two, four, ten, fifteen, or twenty percent margin in either individual values, range(s) of values and/or endpoints defining range(s) of values.

This disclosure relates to engines for aircraft with thrust augmentation via partial core exhaust reheat, thus providing increased thrust, e.g., for high demand portions of flight such as take-off, top of climb (TOC), and/or other challenging flight conditions. Providing thrust augmentation via partial core exhaust reheat meets the needs of these high demand portions of flight without requiring an oversized engine that produces more thrust than necessary during all other portions of flight, thus increasing efficiency. Although detailed herein with respect to an exemplary turbofan engine, the aspects and features of this disclosure are also applicable to other aircraft engines such as open rotor engines, turboprop engines, and/or other suitable engines.

In aspects, thrust augmentation of from 2% to 30% is provided via the partial core exhaust reheat of this disclosure; in other aspects, thrust augmentation of from 10% to 20% is provided via the partial core exhaust reheat of this disclosure. In aspects of this disclosure, from about 0.10% to about 25% (by mass) of the total airflow through the engine (e.g., including both bypass airflow and core airflow), is utilized for thrust augmentation. Thus, thrust augmentation is provided for high demand portions of flight while reducing the efficiency impact during other portions of flight that do not have such high thrust demands. In addition, by diverting only a relatively small portion of airflow for thrust augmentation, pressure loss concerns are significantly reduced if not eliminated.

Further, in aspects of this disclosure, thrust augmentation via partial core exhaust reheat is selectively enabled/disabled, thus providing thrust augmentation as needed (and avoiding thrust augmentation when not needed). For example, in a thrust augmentation enabled configuration, airflow is diverted for thrust augmentation to enable partial core exhaust reheat. On the other hand, in a non-augmented thrust configuration (or thrust augmentation disabled configuration), airflow is not diverted and, thus, partial core exhaust reheat does not occur.

Alternatively or additionally, thrust augmentation via partial core exhaust reheat is selectively adjusted, thus providing an amount of thrust augmentation as needed. For example, an amount of airflow diverted for thrust augmentation to enable partial core exhaust reheat may be varied, based on thrust requirements and/or other factors, thus providing the thrust augmentation that is needed (and avoiding thrust augmentation that is not needed). In these and/or other aspects, the amount of fuel supplied to the thrust augmenter may be controlled to enable control of the temperature of the exhaust flow during reheat.

The thrust augmentation via partial core exhaust reheat of this disclosure is fuel agnostic and may provide augmented thrust using the same fuel as the engine core or using a different fuel. Suitable fuels include, without limitation, gas, hydrogen, hybrid combinations thereof, and/or other suitable fuels. More specifically, and again without limitation, suitable fuels include Jet-A, Kerosene, SAF (Sustainable Aviation Fuel), methane, natural gas, combinations thereof, etc.

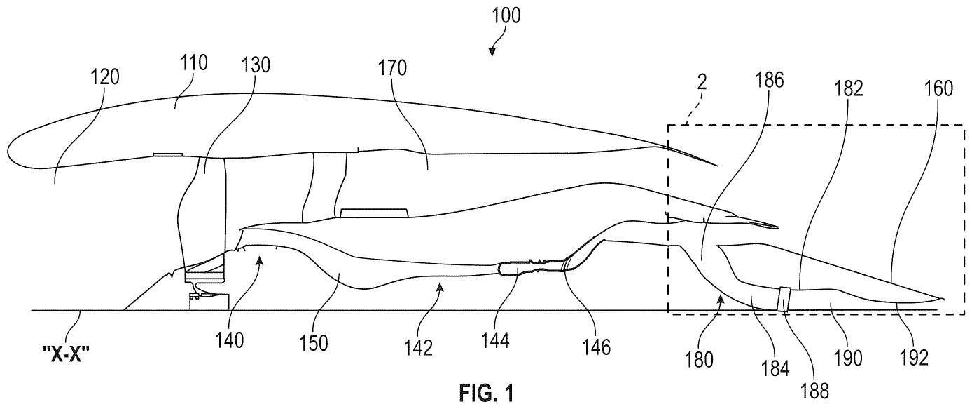

Referring generally to FIG. 1, a portion of an engine 100 (shown as but not limited to a turbofan engine) is provided in accordance with this disclosure. As noted above, other suitable engine configurations for use in accordance with the aspects of this disclosure include turboprop and open rotor engines. Turbofan engine 100 is centered about a central longitudinal axis X-X. Accordingly, while the side, cross-sectional view of FIG. 1 illustrates only the portion of turbofan engine 100 disposed above longitudinal axis X-X, it is understood that turbofan engine 100 may define a substantially symmetrical portion below longitudinal axis X-X. Thus, to the extent any of the aspects and/or features of turbofan engine 100 disposed above longitudinal axis X-X are detailed herein in the singular, it is understood that corresponding aspects and/or features of turbofan engine 100 may also be provided below longitudinal axis X-X.

Turbofan engine 100 includes a nacelle 110 defining an intake 120, a fan 130 rotatably mounted within nacelle 110 downstream of intake 120, an engine core 140 downstream of fan 130 and defining a core airflow duct 150, and an exhaust nozzle 160 downstream of engine core 140. Turbofan engine 100 further defines a bypass airflow duct 170 downstream of fan 130 that extends to a bypass exhaust, bypassing engine core 140.

Continuing with reference to FIG. 1, airflow entering intake 120 is accelerated through fan 130, where the airflow is divided between bypass airflow duct 170 and core airflow duct 150. The acceleration of air through fan 130 and along bypass airflow duct 170 to the bypass exhaust provides the majority of thrust produced by turbofan engine 100. In aspects, at least 80% (by mass) of the airflow entering intake 120 flows along bypass airflow duct 170 (thus defining a bypass ratio of at least 8:1); in other aspects, at least 90% (by mass) of the airflow entering intake 120 flows along bypass airflow duct 170 (thus defining a bypass ratio of at least 9:1) In aspects, up to 95% (by mass) of the airflow entering intake 120 flows along bypass airflow duct 170 (thus defining a bypass ratio of up to 19:1). However, other suitable airflow percentages and/or bypass ranges are also contemplated.

Engine core 140 includes one or more compressors 142, a core combustion chamber 144, and one or more turbines 146. Fuel is added to core combustion chamber 144 to mix with the air flowing along core airflow duct 150 and is ignited to achieve combustion, such that turbofan engine 100 also produces thrust via core airflow duct 150. The air flowing along core airflow duct 150 may be, in aspects, at most 20% (by mass) of the airflow entering intake 120; in other aspects, at most 10% (by mass) of the airflow entering intake 120. The air flowing along core airflow duct 150 may be, in aspects, at least 5% (by mass) of the airflow entering intake 120; at least 3% (by mass) of the airflow entering intake 120, e.g., for a ducted engine; or at least 0.7% (by mass) of the airflow entering intake 120, e.g., for an open rotor engine.

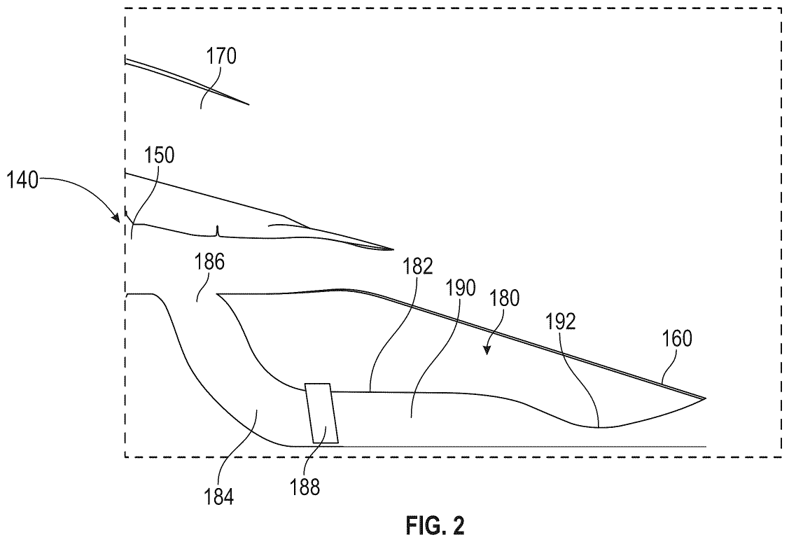

FIG. 2 is an enlarged view of the area of detail designated as “2” in FIG. 1 according to exemplary aspects of the present disclosure. As shown in FIG. 1 and FIG. 2 collectively, turbofan engine 100 further includes a thrust augmenter 180. Thrust augmenter 180 includes a liner 182 defining at least a portion of an augmented thrust airflow duct 184 and is configured to receive (selectively receive, in aspects) air diverted from core airflow duct 150 upstream of exhaust nozzle 160. Thrust augmenter 180 further includes an inlet 186, through which airflow is diverted from core airflow duct 150, a spray bar 188 (or other suitable fuel injector) configured to introduce fuel into the airflow to facilitate combustion, an augmenter combustion chamber 190 wherein the air-fuel mixture is reheated, and a nozzle 192 (e.g., a fixed converging-diverging, a variable nozzle, etc.) downstream of augmenter combustion chamber 190. Thrust augmenter 180 may further include an igniter (not shown) configured to ignite the air-fuel mixture within augmenter combustion chamber 190 to achieve combustion. However, although shown with a spray bar 188 fuel injector, other suitable thrust augmenter configurations are also contemplated such as, for example and without limitation, trapped vortex and rotating detonation. The features of thrust augmenter 180 cooperate to generate augmented thrust via the air flowing along augmented thrust airflow duct 184 and, more specifically, via the reheating of air within augmenter combustion chamber 190 and flow of the reheated air from augmenter combustion chamber 190 through nozzle 192 (shown as a fixed converging-diverging nozzle) to exhaust nozzle 160. This additional thrust, as noted above, may provide thrust augmentation of from 2% to 30%, in aspects, or 10% to 20%, in other aspects. Fuel may be provided to spray bar 188 (or other thrust augmenter) from the main combustor fuel tank, e.g., via routing through the rear frame, or may be provided via a separate fuel system, e.g., including a tank, pump, and valves located in the tail cone and separate from the main combustor fuel system.

Downstream of nozzle 192, the air flowing along augmented thrust airflow duct 184 is exhausted via exhaust nozzle 160. Alternatively, augmented thrust airflow duct 184 may rejoin core airflow duct 150 upstream of exhaust nozzle 160, thus defining a recombined flow duct to exhaust nozzle 160.

The airflow within augmenter combustion chamber 190 may be reheated, in aspects, to at least a temperature of 2100° F., in other aspects, to at least a temperature of 2200° F., or, in still other aspects, to at least a temperature of 2300° F.

Continuing with reference to FIGS. 1 and 2, air flowing along bypass airflow duct 170 is not diverted to augmented thrust airflow duct 184 but, rather, continues downstream to the bypass exhaust (not shown). However, in aspects, air flowing along bypass airflow duct 170 contacts the exterior of or is otherwise routed to thermally couple with a portion of liner 182, e.g., some or all of the portion defining augmenter combustion chamber 190, to cool liner 182 with the bypass airflow. In this manner, the integrity of liner 182 is maintained despite the reheat of airflow to, for example, a temperature of at least 2200° F. In additional or alternative aspects, liner 182 includes a flame tube, is cooled in another manner, or is formed of material resistant to extreme temperatures.

Thrust augmenter 180, in aspects, may receive airflow from core airflow duct 150 downstream of engine core 140. Alternatively or additionally, one or more compressors 142 of engine core 140 (see FIG. 1) may be bled (selectively bled in an ON/OFF and/or variable rate manner, in aspects), to inject airflow to thrust augmenter 180.

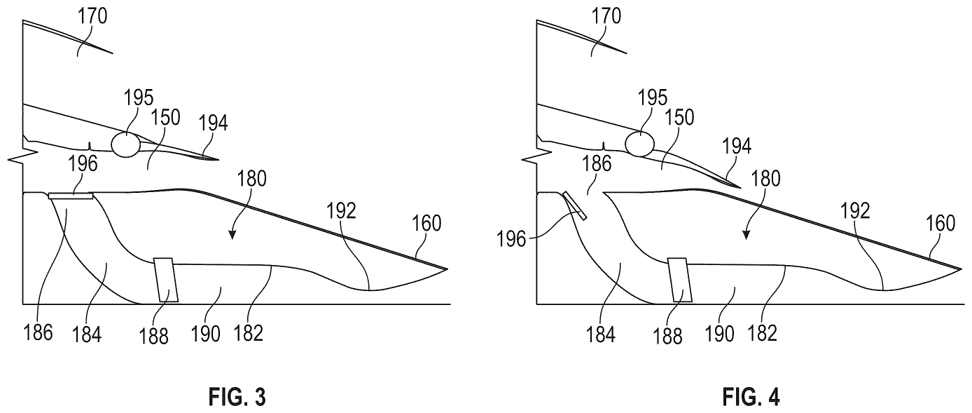

Turning to FIGS. 3 and 4, in aspects, thrust augmenter 180 includes a variable exhaust nozzle (VEN) 194 disposed along core airflow duct 150 downstream of engine core 140 and inlet 186 and upstream of exhaust nozzle 160. VEN 194 is configured to move between an opening position (FIG. 3), wherein airflow along core airflow duct 150 to exhaust nozzle 160 is substantially uninhibited, and one or more at least partially closed positions (FIG. 4), wherein airflow along core airflow duct 150 to exhaust nozzle 160 is reduced. In aspects, one of the at least partially closed positions is a fully closed wherein airflow along core airflow duct 150 to exhaust nozzle 160 is inhibited. In additional or alternative aspects, VEN 194 is movable to a plurality of partially closed positions, each defining a different degree of airflow reduction.

The position of VEN 194 determines the portion of airflow that continues along core airflow duct 150 to exhaust nozzle 160 and the portion of airflow that is diverted through inlet 186 of thrust augmenter 180 and along augmented thrust airflow duct 184. More specifically, in the open position (FIG. 3) or a more open position of VEN 194, more or substantially all of the airflow continues along core airflow duct 150 to exhaust nozzle 160. However, in partially closed positions (FIG. 4), more of the airflow, following a pressure differential, is diverted through inlet 186 of thrust augmenter 180 and along augmented thrust airflow duct 184. The amount of airflow diverted depends on the extent of closure of VEN 194 and, thus, the extent of the pressure differential between core airflow duct 150 and augmented thrust airflow duct 184. In aspects where VEN 194 is movable to a fully closed position, substantially all of the airflow is diverted through inlet 186 of thrust augmenter 180 and along augmented thrust airflow duct 184.

VEN 194, in aspects, may be electronically positioned, e.g., via a motor 195, and controlled, e.g., by an engine control system (not shown) of turbofan engine 100, such that appropriate airflow is diverted to thrust augmenter 180 to generate augmented thrust, e.g., based upon thrust requirements. Further, since the position of VEN 194 is related to the amount of airflow along augmented thrust airflow duct 184, spray bar 188 may be controlled based on the position of VEN 194 such that an appropriate amount of fuel for the airflow along augmented thrust airflow duct 184 is introduced into the augmenter combustion chamber 190 for reheating the airflow and generating augmented thrust.

FIG. 3 is an enlarged, cross-sectional view of a portion of another turbofan engine in accordance with this disclosure with the thrust augmenter 180 in a first configuration. FIG. 4 is an enlarged, cross-sectional view of the portion of the turbofan engine of FIG. 3, with the thrust augmenter 180 in a second configuration. As shown in FIGS. 3 and 4 collectively, thrust augmenter 180 includes a door 196 configured to selectively open/close the flow of air from core airflow duct 150 through inlet 186 of thrust augmenter 180 and along augmented thrust airflow duct 184. More specifically, in a closed position of door 196 (FIG. 3), inlet 186 is blocked such that air flowing along core airflow duct 150 downstream of engine core 140 continues along core airflow duct 150 to exhaust nozzle 160 without being diverted to augmented thrust airflow duct 184. As such, no thrust augmentation is provided. In an open position of door 196 (FIG. 4), on the other hand, inlet 186 is open such that at least some of the air flowing along core airflow duct 150 downstream of engine core 140 may be diverted through inlet 186 of thrust augmenter 180 and along augmented thrust airflow duct 184, thereby providing augmented thrust.

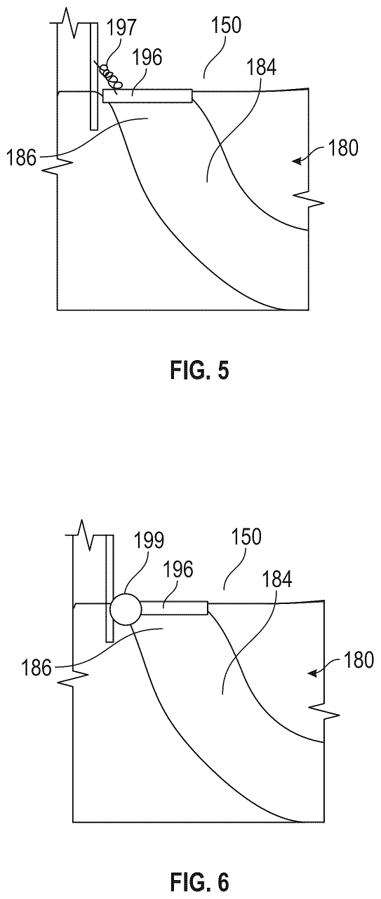

FIG. 5 is a cross-sectional view illustrating a door configured for use with the thrust augmenter 180 of the turbofan engine of FIG. 1. As shown in FIG. 5, in aspects, door 196 is spring loaded, e.g., via spring 197, that biases door 196 towards the closed position, wherein inlet 186 is blocked and airflow along augmented thrust airflow duct 184 is inhibited. In aspects, the pressure differential change between core airflow duct 150 and augmented thrust airflow duct 184 due to VEN 194 moving from the open position (FIG. 3) to one of the at least one partially closed positions (FIG. 4) is sufficient to overcome at least a portion of the bias of spring 197 to at least partially open door 196, thereby enabling the flow of air through inlet 186 and along augmented thrust airflow duct 184 to produce augmented thrust. In aspects, door 196 is fully opened when VEN 194 is disposed in a partially closed position, thus providing the full augmented thrust. In other aspects, door 196 is incrementally opened inversely proportionally (or otherwise in relation) to the extent of closure of VEN 194, such that augmented thrust is produced correspondingly.

FIG. 6 is a cross-sectional view illustrating another door configured for use with the thrust augmenter of the turbofan engine of FIG. 1. As shown in FIG. 6, in conjunction with FIGS. 3 and 4, in aspects, door 196 is configured as a VEN that is electronically positionable, e.g., via a motor 199. Motor 199, in turn, may be controlled by the engine control system (not shown) of turbofan engine 100, such that appropriate airflow is diverted to thrust augmenter 180 to generate augmented thrust, e.g., based upon thrust requirements. Alternatively, motor 199 may be controlled to open door 196 when VEN 194 is disposed in a partially closed position, or based on the position of VEN 194 such that the position of door 196 is incrementally opened inversely proportionally (or otherwise in relation) to the extent of closure of VEN 194.

In aspects, since the position of door 196 is related to the amount of airflow along augmented thrust airflow duct 184, spray bar 188 may be controlled based on the position of door 196 (whether spring loaded, motor controlled, or otherwise configured) such that an appropriate amount of fuel is introduced into the augmenter combustion chamber 190 for reheating the airflow and, in turn, generating the appropriate augmented thrust.

In aspects, with door 196 (whether spring loaded, motor controlled, or otherwise configured) disposed in the closed position blocking airflow along augmented thrust airflow duct 184, augmented thrust airflow duct 184 defines a resonator cavity tuned to reduce the noise of air flowing along core airflow duct 150 to exhaust nozzle 160 (see FIG. 2).

Aspects of this disclosure may be further described by reference to the following clauses:

An aircraft engine, comprising: a fan; an engine core downstream of the fan; a bypass airflow duct downstream of the fan and positioned externally of the engine core, wherein the fan accelerates airflow through the bypass airflow duct to produce a first thrust; a core airflow duct downstream of the fan and extending through the engine core, the core airflow duct including a core combustion chamber, wherein airflow through the core airflow duct is combusted within the core combustion chamber to produce a second thrust; and an augmented thrust airflow duct in communication with the core airflow duct, the augmented thrust airflow duct including an augmenter combustion chamber, wherein airflow diverted from the core airflow duct through the augmented thrust airflow duct is combusted within the augmenter combustion chamber to produce an augmented thrust, wherein at least one of: the augmented thrust is from 2% to 30% of a sum of the first thrust and the second thrust and wherein the airflow through the core airflow duct is from 5% to 20% of a total airflow through the core airflow duct and the bypass airflow duct, or the airflow through the core airflow duct and/or the airflow through the augmented thrust airflow duct are controlled to thereby control diversion of airflow from the core airflow duct to the augmented thrust airflow duct.

The aircraft engine according to the preceding clause, wherein the airflow through the augmented thrust airflow duct is from about 0.10% to about 25% of the total airflow through the core airflow duct and the bypass airflow duct.

The aircraft engine according to any preceding clause, further comprising a fuel injector configured to inject fuel into the augmenter combustion chamber.

The aircraft engine according to the preceding clause, wherein the fuel injector is a spray bar.

The aircraft engine according to any preceding clause, wherein the augmented thrust airflow duct includes a fixed converging-diverging nozzle downstream of the augmenter combustion chamber.

The aircraft engine according to any preceding clause, further comprising an exhaust nozzle for exhausting airflow, and wherein the augmented thrust airflow duct and the core airflow duct recombine upstream of the exhaust nozzle.

The aircraft engine according to any preceding clause, wherein the augmented thrust airflow duct includes a liner, and wherein the airflow through the bypass airflow duct is thermally coupled with at least a portion of the liner to cool the liner.

The aircraft engine according to any preceding clause, wherein the augmented thrust airflow duct includes an inlet in communication with the core airflow duct downstream of the engine core.

The aircraft engine according to any preceding clause, wherein the engine core includes a compressor in communication with the augmented thrust airflow duct such that bleeding the compressor diverts airflow from the core airflow duct to the augmented thrust airflow duct.

The aircraft engine according to the preceding clause, wherein the diversion of airflow from the core airflow duct to the augmented thrust airflow duct is controllable.

The aircraft engine according to any preceding clause, further comprising a variable exhaust nozzle (VEN) disposed within the core airflow duct downstream of the engine core, the VEN adjustable between an open position and one or more at least partially closed positions to control the diversion of airflow from the core airflow duct to the augmented thrust airflow duct.

The aircraft engine according to the preceding clause, wherein an engine control system controls adjustment of the VEN.

The aircraft engine according to the preceding clause or the clause preceding that, wherein injection of fuel into the augmenter combustion chamber is controlled based on a position of the VEN.

The aircraft engine according to any preceding clause, further comprising a door disposed within an inlet to the augmented thrust airflow duct, the door movable between a closed position inhibiting the diversion of airflow from the core airflow duct to the augmented thrust airflow duct and at least one open position permitting the diversion of airflow from the core airflow duct to the augmented thrust airflow duct.

The aircraft engine according to the preceding clause, wherein the door is actively driven between the closed position and the at least one open position or wherein the door is passively moved between the closed position and the at least one open position based on a pressure differential between the core airflow duct and the augmented thrust airflow duct.

The aircraft engine according to the preceding clause, further comprising a variable exhaust nozzle (VEN) disposed within the core airflow duct downstream of the engine core, wherein adjustment of the VEN changes the pressure differential between the core airflow duct and the augmented thrust airflow duct enabling movement of the door.

The aircraft engine according to any preceding clause, wherein, in the closed position of the door, the augmented thrust airflow duct defines a resonator cavity configured to minimize exhaust noise.

The aircraft engine according to any preceding clause, wherein injection of fuel into the augmenter combustion chamber is controlled based on a position of the door.

While several aspects and features of this disclosure are described above and shown in the drawings, it is not intended that this disclosure be limited thereto, as it is intended that the disclosure be as broad in scope as the art will allow and that the specification be read likewise. Therefore, the above description should not be construed as limiting, but merely as exemplifications of particular aspects. Additionally, the aspects and features shown or described in connection with certain configurations may be combined with the aspects and features of certain other configurations without departing from the scope of this disclosure, and such modifications and variations are included within the scope of this disclosure. Accordingly, the subject matter of this disclosure is not limited by what has been particularly shown and/or described.

1. An aircraft engine, comprising:
a fan;
an engine core downstream of the fan;
a bypass airflow duct downstream of the fan and positioned externally of the engine core, wherein the fan accelerates airflow through the bypass airflow duct to produce a first thrust;
a core airflow duct downstream of the fan and extending through the engine core, the core airflow duct including a core combustion chamber, wherein airflow through the core airflow duct is combusted within the core combustion chamber to produce a second thrust; and
an augmented thrust airflow duct including an inlet in communication with the core airflow duct, an augmenter combustion chamber downstream of the inlet, and a nozzle including a converging portion downstream of the augmenter combustion chamber, wherein the augmented thrust airflow duct is configured such that airflow diverted from the core airflow duct flows through the inlet of the augmented thrust airflow duct, through the augmenter combustion chamber wherein the diverted airflow is combusted within the augmenter combustion chamber to produce an augmented thrust, and through the nozzle before recombining with the airflow through the core airflow duct downstream of the nozzle,
wherein the airflow through the core airflow duct is from 5% to 20% of a total airflow through the core airflow duct and the bypass airflow duct.

2. The aircraft engine according to claim 1, wherein the airflow through the augmented thrust airflow duct is from about 0.10% to about 25% of the total airflow through the core airflow duct and the bypass airflow duct.

3. The aircraft engine according to claim 1, further comprising a fuel injector configured to inject fuel into the augmenter combustion chamber.

4. The aircraft engine according to claim 3, wherein the fuel injector is a spray bar.

5. The aircraft engine according to claim 1, wherein the nozzle of the augmented thrust airflow duct includes a fixed converging-diverging nozzle downstream of the augmenter combustion chamber.

6. The aircraft engine according to claim 1, further comprising an exhaust nozzle for exhausting airflow.

7. The aircraft engine according to claim 1, wherein the augmented thrust airflow duct includes a liner, and wherein the airflow through the bypass airflow duct is thermally coupled with at least a portion of the liner to cool the liner.

8. The aircraft engine according to claim 1, wherein the inlet of the augmented thrust airflow duct is in communication with the core airflow duct downstream of the engine core.

9. The aircraft engine according to claim 1, wherein the engine core includes a compressor in communication with the augmented thrust airflow duct.

10. The aircraft engine according to claim 1, wherein the diversion of airflow from the core airflow duct to the augmented thrust airflow duct is controllable.

11. An aircraft engine, comprising:
a fan;
an engine core downstream of the fan;
a bypass airflow duct downstream of the fan and positioned externally of the engine core, wherein the fan accelerates airflow through the bypass airflow duct to produce a first thrust;
a core airflow duct downstream of the fan and extending through the engine core, the core airflow duct including a core combustion chamber, wherein airflow through the core airflow duct is combusted within the core combustion chamber to produce a second thrust;
an augmented thrust airflow duct in communication with the core airflow duct, the augmented thrust airflow duct including an augmenter combustion chamber, wherein airflow diverted from the core airflow duct through the augmented thrust airflow duct is combusted within the augmenter combustion chamber to produce an augmented thrust;
a variable exhaust nozzle (VEN) movable to at least a first position, wherein the VEN is closed a first amount, and a second position, wherein the VEN is closed a second amount greater than the first amount, the VEN configured to divert airflow from the core airflow duct to the augmented thrust airflow duct in each of the first position and the second position, the first position of the VEN corresponding to a first amount of diverted airflow and the second position of the VEN corresponding to a second amount of diverted airflow greater than the first amount of diverted airflow; and
a controller configured to control an amount of fuel supplied to the augmenter combustion chamber based on the position of the VEN such that, in the first position of the VEN, a first amount of fuel corresponding to the first amount of airflow is supplied to the augmenter combustion chamber and such that, in the second position of the VEN, a second amount of fuel corresponding to the second amount of airflow is supplied to the augmenter combustion chamber, the second amount of fuel greater than the first amount of fuel.

12. (canceled)

13. The aircraft engine according to claim 11, wherein an engine control system controls adjustment of the VEN.

14. (canceled)

15. The aircraft engine according to claim 11, further comprising a door disposed within an inlet to the augmented thrust airflow duct, the door movable between a closed position inhibiting the diversion of airflow from the core airflow duct to the augmented thrust airflow duct and at least one open position permitting the diversion of airflow from the core airflow duct to the augmented thrust airflow duct.

16. (canceled)

17. The aircraft engine according to claim 15, wherein the door is passively moved between the closed position and the at least one open position based on a pressure differential between the core airflow duct and the augmented thrust airflow duct.

18. The aircraft engine according to claim 15, wherein adjustment of the position of the VEN changes the pressure differential between the core airflow duct and the augmented thrust airflow duct enabling movement of the door.

19. (canceled)

20. The aircraft engine according to claim 15, wherein, in the closed position of the door, the augmented thrust airflow duct defines a resonator cavity configured to minimize exhaust noise.

21. An aircraft engine, comprising:
a fan;
an engine core downstream of the fan;
a bypass airflow duct downstream of the fan and positioned externally of the engine core, wherein the fan accelerates airflow through the bypass airflow duct to produce a first thrust;
a core airflow duct downstream of the fan and extending through the engine core, the core airflow duct including a core combustion chamber, wherein airflow through the core airflow duct is combusted within the core combustion chamber to produce a second thrust;
an augmented thrust airflow duct in communication with the core airflow duct, the augmented thrust airflow duct including an augmenter combustion chamber, wherein airflow diverted from the core airflow duct through the augmented thrust airflow duct is combusted within the augmenter combustion chamber to produce an augmented thrust;
a door movable to at least a first position, wherein the door is open a first amount, and a second position, wherein the door is open a second amount greater than the first amount, the door configured to divert airflow from the core airflow duct to the augmented thrust airflow duct in each of the first position and the second position, the first position of the door corresponding to a first amount of diverted airflow and the second position of the door corresponding to a second amount of diverted airflow greater than the first amount of diverted airflow; and
a controller configured to control an amount of fuel supplied to the augmenter combustion chamber based on the position of the door such that, in the first position of the door, a first amount of fuel corresponding to the first amount of airflow is supplied to the augmenter combustion chamber and such that, in the second position of the door, a second amount of fuel corresponding to the second amount of airflow is supplied to the augmenter combustion chamber, the second amount of fuel greater than the first amount of fuel.

22. The aircraft engine according to claim 21, wherein an engine control system controls adjustment of the door.

23. The aircraft engine according to claim 21, wherein the door is disposed within an inlet to the augmented thrust airflow duct.

24. The aircraft engine according to claim 21, wherein the door is passively moved between at least the first position and the second position based on a pressure differential between the core airflow duct and the augmented thrust airflow duct.
